(19) United States
(12) Patent Application Publication
(10) Pub. No.: US 2002/0136014 A1
(43) Pub. Date: Sep. 26, 2002

(54) Modular element for supporting light, sound and image sources and knock-down structures made up with it

(75) Inventor: Paolo Targetti, Florence (IT)

Correspondence Address: STEINBERG & RASKIN, P.C., 1140 AVENUE OF THE AMERICAS, 15th FLOOR, NEW YORK, NY, 10036-5803, US

(73) Assignee: Targetti Sankey S.p.A.

(21) Appl. No.: 10/100,613

(22) Filed: Mar. 18, 2002

(30) Foreign Application Priority Data
Mar. 23, 2001 (IT) FI2001U000027

(51) Int. Cl. F21V 19/02

(52) U.S. Cl. 362/372; 362/145; 362/285; 362/427

(57) ABSTRACT

A modular element for supporting light, sound and image sources (2) and realizing knock-down structures, the element comprising a box-shaped and substantially flat body (1) on which there are provided windows (3) arranged side by side and delimited by respective grooved edges (4) capable of forming seatings for each window with which there can engage a connection base (5) of said sources to be mounted within them.

### DESCRIPTION

Field of the Invention

The present invention relates to a modular element for supporting light, sound and image sources and multimedia instruments in general and also concerns the structures made up with it and intended, though not exclusively so, for positioning such sources in space without being bound by existing supporting structures.

Structures for supporting light sources and audiovisual equipment are already known, such as in particular lattice beam structures to which the lighting fixtures can be attached. These structures can be configured in a wide variety of forms due to the availability of many types of joints and bends by means of which the individual structural modules can be joined together. As in every sector in which the functional forms must also have a considerable aesthetic appeal, designers in the sector of fixtures and equipment for the illumination of environments, as also in the sector concerned with sound and image diffusion, are constantly looking for aesthetically original solutions that nevertheless have also functional characteristics that have to be either better or at least equal to those of the known solutions. In the case of lighting structures the problem is generally that of not only simplifying the operation of mounting the lighting fixtures to the greatest possible extent, this without prejudicing the possibility of readily orienting these fixtures either during the mounting phase or after the installation of the structure, but also simplifying the module assembling operations as much as possible.

The object of the present invention is to provide a modular element for supporting light, sound and image sources for the realization of knock-down structures capable of satisfying the needs described above.

### SUMMARY OF THE INVENTION

The above object is attained with the modular element in accordance with the invention, which comprises a box-shaped and substantially flat body with windows arranged side by side and delimited by grooved edges suitable for forming in each window seatings for engaging therewith the connecting base of a lighting fixture to be mounted in the window. In particular, two opposite ends of the box-shaped body are open to form the engagement seatings for bends or joints by means of which the element is connected to other modular elements, thus rendering possible the realization of complexly shaped lighting structures.

### BRIEF DESCRIPTION OF THE DRAWINGS

The invention will now be illustrated in greater detail by the description given below of a particular embodiment thereof, which is to be considered as an example and not limitative in any way, said description making reference to the attached drawings of which:

FIG. 1 shows a perspective view of a portion of the modular element in accordance with the invention;

FIG. 2 shows an exploded view of a portion of the modular element in accordance with the invention;

FIG. 3 shows a perspective view of a portion of the modular element in accordance with the invention before the mounting of the perimetrical frames.

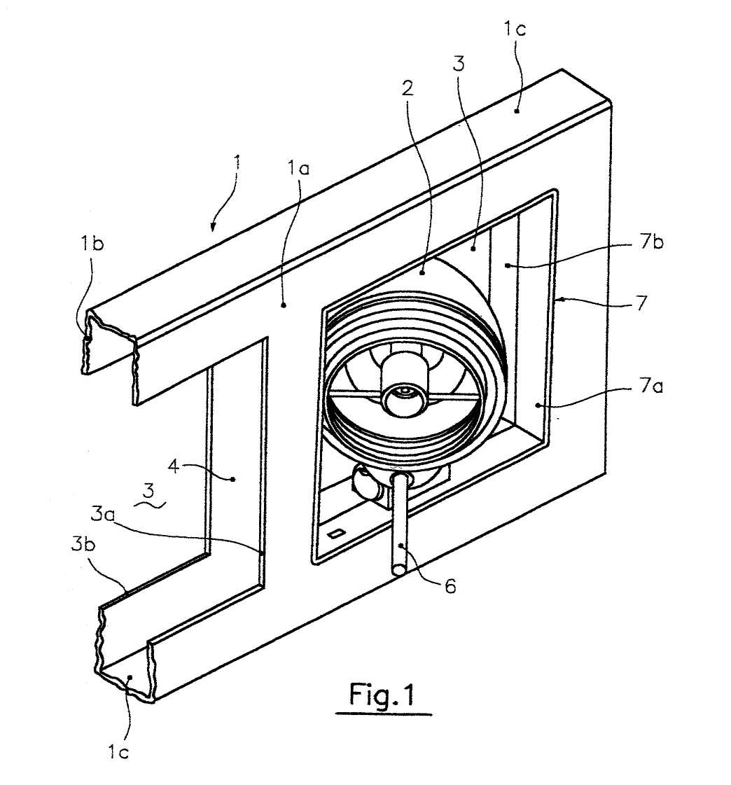

### DESCRIPTION OF AN EXAMPLE OF THE INVENTION

It should be noted that the present description of a particular embodiment of the invention refers to the case of a modular element intended to support light sources, but it can obviously be extended also to the more general case of any other type of equipment for the diffusion of sounds, images and multi-media effects in general.

With reference to the figures, 1 generally indicates a portion of a modular element according to the invention in the form of a box-shaped and substantially flat body, in which there is mounted a lamp 2 of the spotlight type. More particularly, box-shaped body 1 is formed by two flat and parallel faces 1a and 1b that are substantially rectangular and connected along the pairs of longer sides by means of longitudinal sides 1c. The two ends 1d of box-shaped body 1, delimited by the two pairs of shorter sides of the two faces 1a and 1b, are open to form corresponding seatings to engage therewith bends and joints for connecting the element to another modular element.

On the two flat faces 1a and 1b there are formed correspondingly openings 3a and 3b that define windows 3 within which there can be accommodated spotlight 2, as shown in the drawing, or the power supply unit of a spotlight or of a group of spotlights arranged in the adjacent windows.

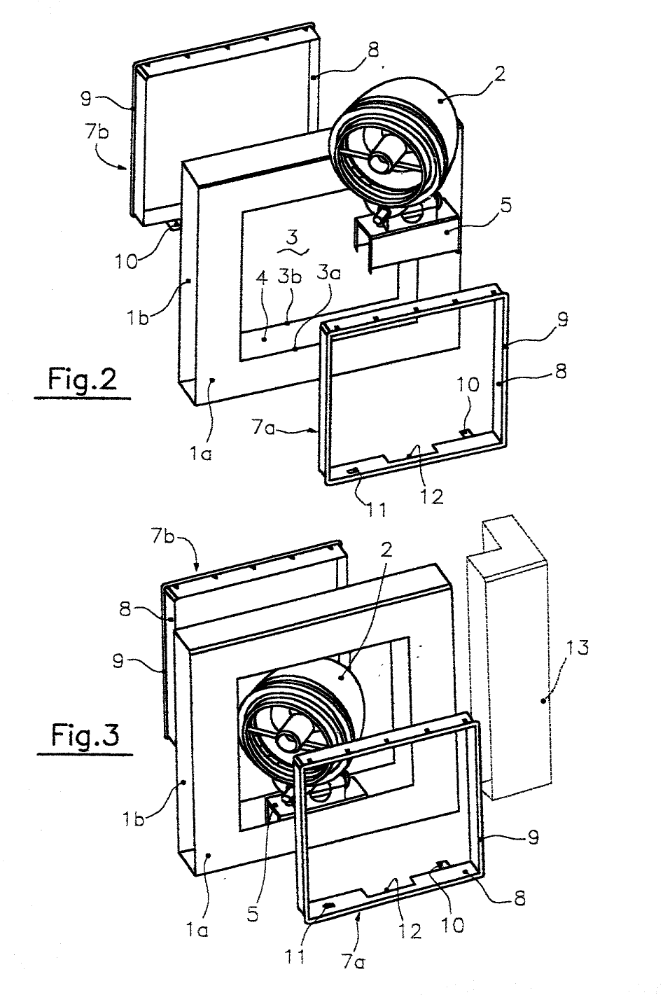

Windows 3 are delimited by a grooved edge 4, defined by the space comprised between the faces 1a and 1b of box-shaped body 1, within which there can be arranged a connecting base 5 of spotlight 2. As shown in FIG. 2, base 5 has a substantially C-shaped transverse section of which the two legs—though this cannot be seen in the drawing—diverge slightly, so that the application of a moderate force permits the base to be forced into edge groove 4 and to form a readily reversible connection with it. Spotlight 2 is pivotally connected to base 5 in a known way and can therefore be oriented as desired by means of a small lever 6.

Each window is provided with a perimetrical frame 7 made up of two parts 7a and 7b to be applied, respectively, to the openings formed on faces 1a and 1b for the purpose of lining and covering the grooved edge and securing the spotlight in the desired position. To this end each part 7a and 7b of frame 7 consists of a tubular element 8, of which both the shape and the size are equal to those of the corresponding opening 3a or 3b, so that frame 7 can engage with said opening, and a flange strip 9 outwardly projecting all around one end of the tubular element 9, said flange strip acting as a stop when it comes to abut against face 1a or 1b. When in position, the two parts 7a and 7b are held together by means of connection tabs 10 projecting from the other end of tubular element 8 and for engaging by means of a snap fit with corresponding seatings 11 arranged in tubular element 8 of the other frame portion. Obviously, however, the two parts can also be held together by means of other connection systems.

Tubular elements 8 of the two frame parts 7a and 7b are also formed with mutually facing cut-outs 12 arranged at an intermediate position of the edge opposite to that from which there projects flange strip 9, the dimensions of the cut-outs being such as to enable them to fit around base 5 of spotlight 2, thus depriving it of all possibility of sliding within its groove.

In a particularly advantageous embodiment of the invention each modular element is provided with four windows 3 arranged side by side and capable of accommodating, for example, alternatively spotlights and their respective power supply units. Obviously, modular elements with a different number of windows and a different arrangement or distribution of the spotlights and the power supply units can also be provided. Furthermore, base 5 of spotlight 2 can engage with either one or the other of the sides that delimit window 3 and extend parallel to longitudinal sides 1c, thus further enhancing the adaptability of the lighting structure to the specific requirements of each user.

The modular elements in accordance with the invention may be connected to each other to form lighting structures that can be rather complex in shape. To this end there are provided accessories in the form of connection bends and joints. By way of example, FIG. 3 illustrates a 90° bend—identified by the reference number 13 and drawn in broken lines—that has a section such as to permit it, upon the application of a moderate force, to become reversibly engaged between ends id of two modular elements that have to be connected with each other. Obviously, differently shaped angle sections can be provided, as well as linear joints, T-shaped joints, crosses, Y-shaped joints, etc., thus allowing a large variety of different lighting structures to be made.

The lighting structures realized in this manner can be suspended in a conventional manner from a ceiling or attached in the manner of a flag to a wall, with the elements aligned either horizontally or vertically. They may also be mounted on columns, even on several stacks or levels if desired, and this particularly in cases in which these structures reach a considerable size.

In a simplified embodiment of the invention that avoids use of finishing frames 7, the spotlights could nevertheless be secured in position by providing pairs of corresponding intermediate cut-outs on faces 1a, 1b along the edges of openings 3a, 3b defining windows 3, said cutouts being intended for being engaged with corresponding projections in the form of small tabs for example, extending from base 5.

It clearly follows from the above description that the modular element in accordance with the invention attains all the objects the invention set out to achieve and, more particularly, that it provides the following advantages:

simplicity of installing and positioning the lighting fixtures;

the electric wiring can be arranged very easily and in complete conformity with specifications;

the lighting fixtures can be readily oriented when spotlights are used;

the system provides an unlimited spatial modularity.

In other embodiments, moreover, windows 3 of the structure realized with the above-described modular element can be appropriately screened with grille panels or with translucent laminates illumined by fluorescent lights placed behind them.

Variations and/or modifications may be brought to the modular element for supporting light, sound and image sources in accordance with the present invention without departing from the scope of the invention as defined by the claims hereinbelow.

1. A modular element for supporting light, sound and image sources (2) for realizing knock-down structures comprising a box-shaped and substantially flat body (1) with windows (3) formed thereon delimited by respective grooved edges (4) capable of forming seatings in each window with which there can engage a connection base (5) of the source to be mounted therewith.

2. A modular element in accordance with claim 1, wherein said box-shaped body (1) comprises two parallel faces (1a,1b) through which there are formed respective corresponding openings (3a, 3b) defining said windows, the two pairs of longer sides of said faces being connected to each other by means of longitudinal sides (1c), the ends of said body comprising seatings for engaging respective connection elements that join it to other modular elements.

3. A modular element in accordance with claim 2, wherein each window has a perimetrical frame (7) applied along its edge.

4. A modular element in accordance with claim 3, wherein said frame has a seating (12) in a position corresponding to the base (5) of said source to engage said base therewith and block it in position.

5. A modular element in accordance with claim 3, wherein said frame (7) is formed by two halves (7a,7b) engageable within the openings defining the respective window and capable of being connected with each other, said seating being formed by two cut-outs (12) correspondingly formed in two opposite sides (8) of said halves.

6. A modular element in accordance with claim 4, wherein said frame (7) is formed by two halves (7a,7b) engageable within the openings defining the respective window and capable of being connected with each other, said seating being formed by two cut-outs (12) correspondingly formed in two opposite sides (8) of said halves.

7. A modular element in accordance with claim 1, wherein said base (5) is removably engaged within the corresponding grooved edge (4).

8. A modular element in accordance with claim 1, wherein said source (2) is pivotally connected to said base (5) in a manner that permits it to be oriented.

9. A modular element according to claim 1, wherein said windows are screened by a grille panel or a translucent laminate illumined from behind by a light source.

10. A knock-down structure realized by combining several modular elements in accordance with any one of the preceding claims by means of connection bends or joints (13) applicable to the ends of said modular elements.
